(19) United States
(12) Patent Application Publication
(10) Pub. No.: US 2007/0295154 A1
(43) Pub. Date: Dec. 27, 2007

(54) CRANKSET ASSEMBLY FOR A BICYCLE

(75) Inventors: Christopher P. D'Aluisio, Watsonville, CA (US); Mark Schroeder, San Jose, CA (US)

Correspondence Address: MICHAEL BEST & FRIEDRICH LLP, 100 E WISCONSIN AVENUE, Suite 3300, MILWAUKEE, WI, 53202, US

(73) Assignee: SPECIALIZED BICYCLE COMPONENTS, INC., Morgan Hill, CA (US)

(21) Appl. No.: 11/426,772

(22) Filed: Jun. 27, 2006

(51) Int. Cl. G05G 1/14

(52) U.S. Cl. 74/594.1

(57) ABSTRACT

A crankset that includes a first crank, a second crank, a first spindle portion, a second spindle portion, and an attachment assembly. Each of the first crank and the second crank include an end adapted to engage a pedal. The first spindle portion includes a first end coupled to the first crank and a second end that has a first engagement member defined by at least one protrusion and at least one cavity. The second spindle portion includes a first end coupled to the second crank and a second end that has a second engagement member defined by at least one protrusion and at least one cavity that are substantially mirror images of the at least one protrusion and the at least one cavity of the first spindle portion, and that engage the corresponding at least one cavity and the at least one protrusion of the first spindle portion.

### BACKGROUND

The present invention relates to a crankset for a bicycle, and more particularly to a two-piece crankset attaching a first crank to a second crank.

Typically, bicycles are propelled by pedals mounted to a crankset at opposite ends of an axle. A typical crankset is equipped with two cranks that each supports a pedal at one end and couples with a spindle adjacent the other end. The spindle is supported for rotation within a bottom bracket of a bicycle. These cranksets transfer energy exerted on the pedals by a rider to forward motion of the bicycle. The crankset typically include one or more sprockets that engage a chain to transfer the rotary motion of the crankset to a rear wheel.

The crankset must be strong enough to prevent breakage under load placed on the pedals and must be adequately stiff to limit loss of energy. Some existing cranksets include a square-tapered rod or spindle fastened to a square tapered hole in the cranks to transfer energy from the pedals. In other cranksets, each crank includes a spindle member that has one or more protrusions that fit into one or more corresponding apertures in the other spindle member to attach the spindle members to each other, as generally disclosed in U.S. Pat. No. 6,443,033. In these cranksets, a relatively small fastener that is permanently attached to one of the spindle members extends between the spindle members to attach with a similarly small threaded opening in the other of the spindle members to facilitate attachment of the spindle members to each other. Typically, these relatively small fasteners provide inadequate strength to rigidly couple the spindle members without a substantial risk of failure.

### SUMMARY

In one embodiment, the invention provides a crankset that includes a first crank, a second crank, a first spindle portion, a second spindle portion, and an attachment assembly. Each of the first crank and the second crank include an end that is adapted to engage a pedal. The first spindle portion includes a first end coupled to the first crank and a second end that has at least one protrusion and at least one cavity. The second spindle portion includes a first end coupled to the second crank and a second end that has at least one protrusion and at least one cavity. The at least one protrusion of the second spindle portion engages the at least one cavity of the first spindle portion and the at least one cavity of the second spindle portion engages the at least one protrusion of the first spindle portion. The attachment assembly attaches the second spindle portion to the first spindle portion.

In another embodiment the invention provides a crankset that includes a first crank, a second crank, a first spindle portion, a second spindle portion, and an attachment assembly. The first spindle portion includes a first end coupled to the first crank and a second end. The second spindle portion includes a first end coupled to the second crank and a second end coupled to the second end of the first spindle portion. The attachment assembly includes an insert threaded into the second spindle portion, and a fastener that extends partially through the first spindle portion and that couples to the insert to attach the second spindle portion to the first spindle portion.

In yet another embodiment the invention provides a crankset that includes a first crank, a second crank, and a spindle. Each of the first crank and the second crank include a first end adapted to engage a pedal, and one of internal and external spline portions on a second end opposite the first end. The spindle includes a first end and a second end. Each of the first end and the second end has the other of internal and external spline portions that are bonded to the one of the internal and external spline portions of the first crank and the second crank.

Other aspects of the invention will become apparent by consideration of the detailed description and accompanying drawings.

### DESCRIPTION OF THE DRAWINGS

FIG. 1 is a side view of a bicycle including a crankset embodying the present invention.

FIG. 2 is a perspective view of the crankset of FIG. 1.

FIG. 3 is an exploded perspective view of the crankset of FIG. 2.

FIG. 4 is a perspective view of a first spindle portion of the crankset of FIG. 3.

FIG. 5 is a perspective view of a second spindle portion of the crankset of FIG. 3.

FIG. 6 is a rear perspective view of the second spindle portion of FIG. 5.

FIG. 7 is a front view of the second spindle portion of FIG. 5.

FIG. 8 is a section view of a portion of the crankset assembly of FIG. 2 taken along line 8-8.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

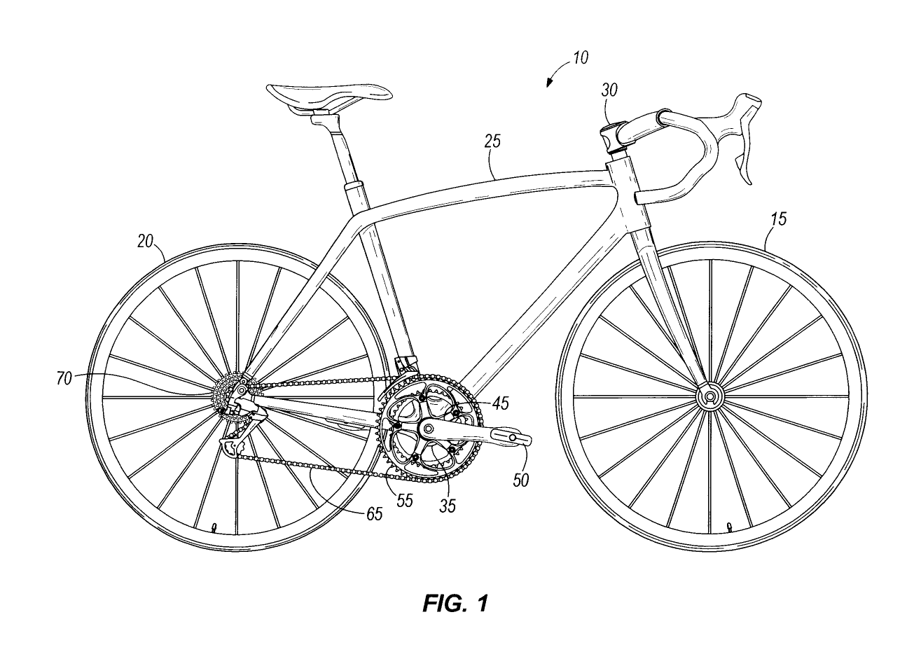

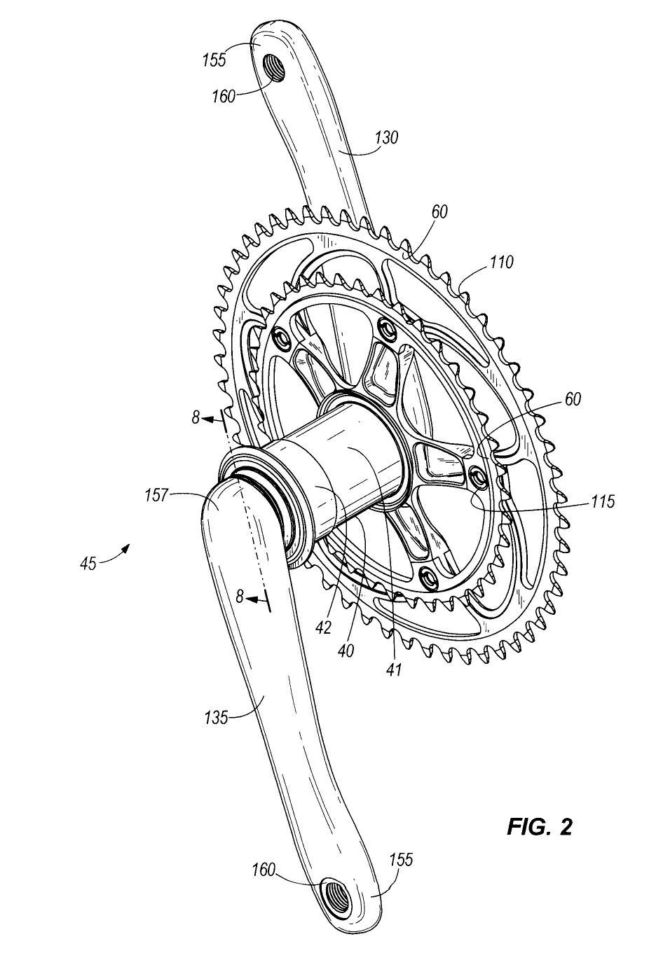

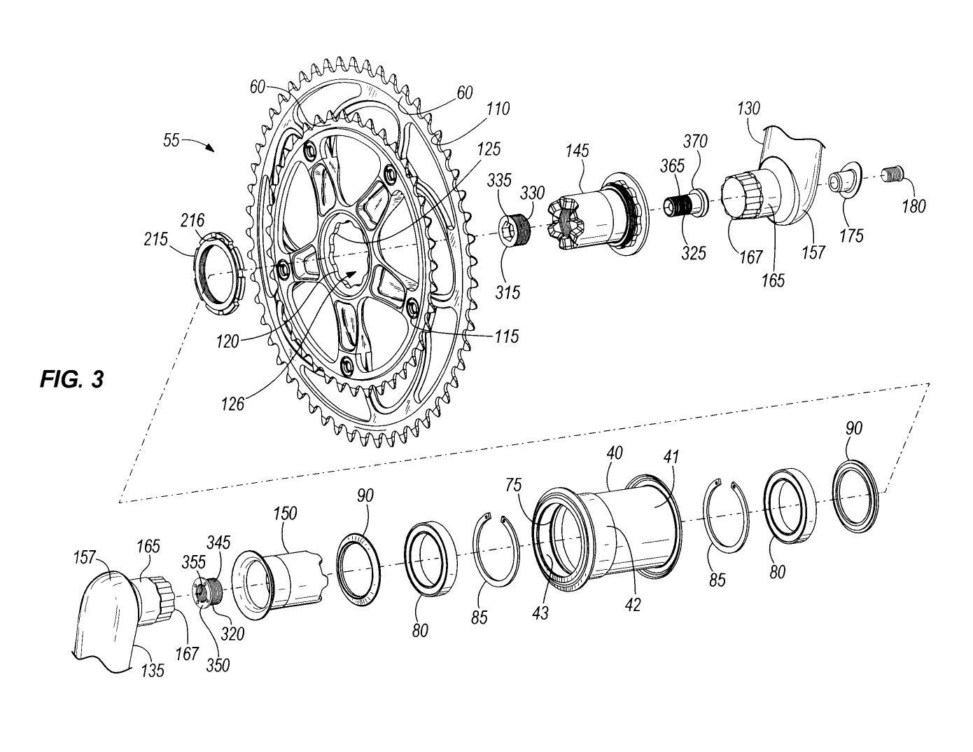

FIG. 1 illustrates a bicycle 10 that includes a front wheel 15, a rear wheel 20, a frame 25, and a steering assembly 30. The frame 25 includes a bottom bracket 35 defining an opening (not shown) and having an inner cylindrical surface that receives a bottom bracket shell 40 (see FIGS. 2 and 3). The frame 25 is formed from a carbon material or other similar materials with adequate strength properties. FIG. 2 shows a crankset 45 that couples to the shell 40. Pedals 50 are attached to the crankset 45 to allow a user to rotate the crankset 45 and to propel the bicycle 10, as is known in the art. As described in detail below, a sprocket assembly 55 is coupled to the crankset 45 and may include one or more chain rings 60 that couple to a chain 65. The chain 65 engages the rear wheel 20 through a rear sprocket assembly 70.

FIGS. 2 and 3 show the shell 40 defined by a cylindrical outer surface. The outer surface of the shell 40 corresponds to the inner cylindrical surface of the bottom bracket 35 to adequately secure the shell 40 within the opening of the bottom bracket 35. The shell 40 is bonded or otherwise adhered to the bottom bracket 35 with an epoxy or other adhesive to inhibit rotation of the shell 40 within the bottom bracket 35. The illustrated shell 40 is formed from two aluminum pieces 41, 42. The two aluminum pieces 41, 42 are bonded to each other using an adhesive to limit rotation of one of the aluminum pieces 41, 42 relative to the other of the aluminum pieces 41, 42. Other embodiments of the shell 40 may be formed from steel or other material (e.g., titanium, etc.). Still other embodiments of the shell 40 may be formed from a single piece or more than two pieces.

The aluminum pieces 41, 42 define a bearing surface 43. The bearing surface 43 defines an inside diameter of the shell 40 adjacent grooves 75. As described in detail below, the bearing surface 43 receives bearings 80. The grooves 75 receive retaining clips 85, and sealing members 90 couple to ends of the shell 40 to allow rotation of the crankset 45.

FIG. 3 shows the sprocket assembly 55 that includes two chain rings 60. Each of the chain rings 60 includes multiple gear teeth 110 and can be fastened to the other chain rings 60 using bolts or other similar fasteners 115. The sprocket assembly 55 includes a spider 120 that couples to each of the chain rings 60 and that has spline members 125 disposed on an inner periphery to define an opening 126.

The crankset 45 includes a first crank 130, a second crank 135, and a spindle having a first spindle portion 145 and a second spindle portion 150. The first and second cranks 130, 135 can be formed from a composite material, such as a carbon/epoxy composite, with other materials also being suitable for use (e.g., plastics, metals, other composites, etc.). In other embodiments, the first and second cranks 130, 135 may be formed from a metal or alloy material (e.g., titanium, steel, aluminum, etc.).

The illustrated first and second cranks 130, 135 define at least partially hollow bodies. Each of the first crank 130 and the second crank 135 includes a first or free end 155 (see FIG. 2) and a second end 157 coupled to the first and second spindle portions 145, 150, respectively. A threaded insert 160 is disposed within the free end 155 of each crank 130, 135 to attach a pedal 50 to each of the respective first and second cranks 130, 135.

As shown in FIG. 3, the second end 157 of each of the first and second cranks 130, 135 defines a bent portion that includes an external attachment portion 165. The external attachment portions 165 of the illustrated embodiment include splines 167 disposed circumferentially about an outer periphery. Other embodiments may include splines disposed circumferentially about an inner periphery.

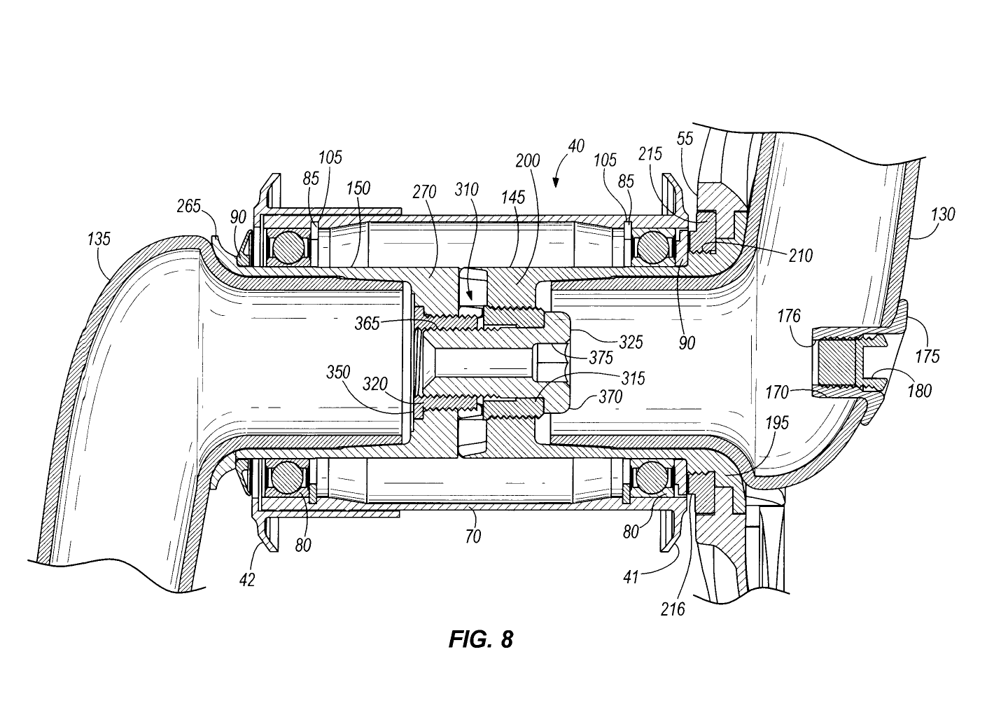

FIG. 8 shows a hole 170 that is disposed adjacent the second end 157 of the first crank 130 and in communication with the hollow interior of the first crank 130. The hole 170 is an access hole for a hex tool (i.e., 6 mm tool) to allow the tool to be inserted into the crank 130 and the first spindle portion 145. A fitting 175 is disposed within the hole 170 and includes a threaded opening 76 to receive a threaded plug or cap 180.

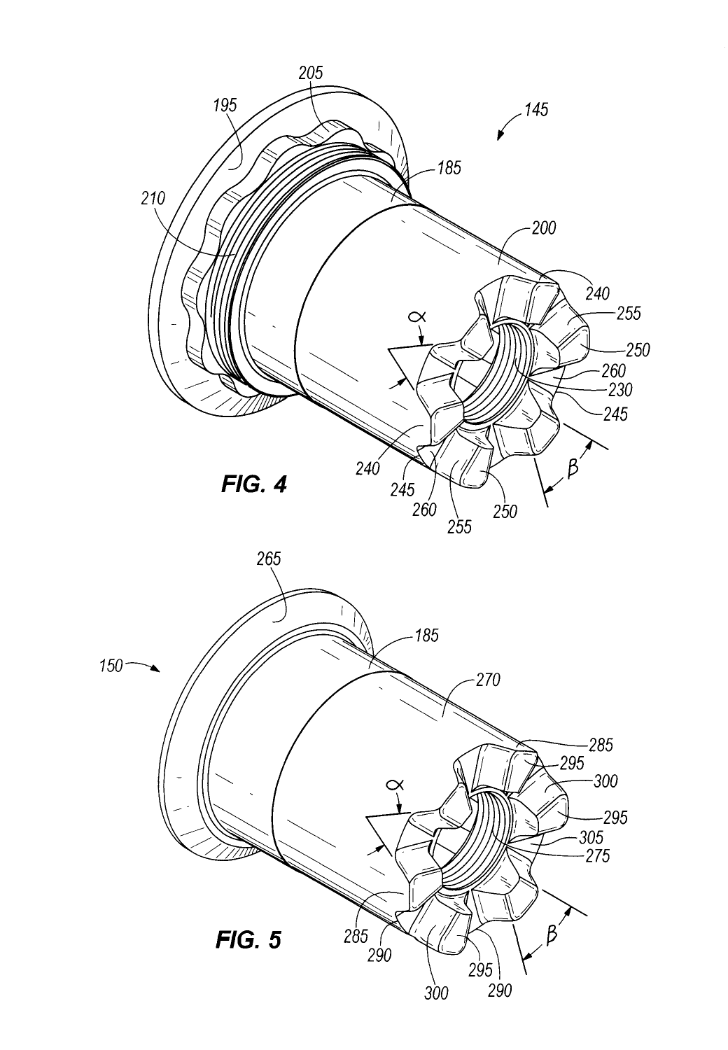

FIGS. 4 and 5 the first and second spindle portions 145, 150. The first and second spindle portions define bearing surfaces 185 that are adapted to engage the bearings 80. In one construction, the first and second spindle portions 145, 150 are formed from metal (e.g., titanium, steel, aluminum, etc.). In other constructions, the first and second spindle portions can be formed from a metal alloy or other durable composites.

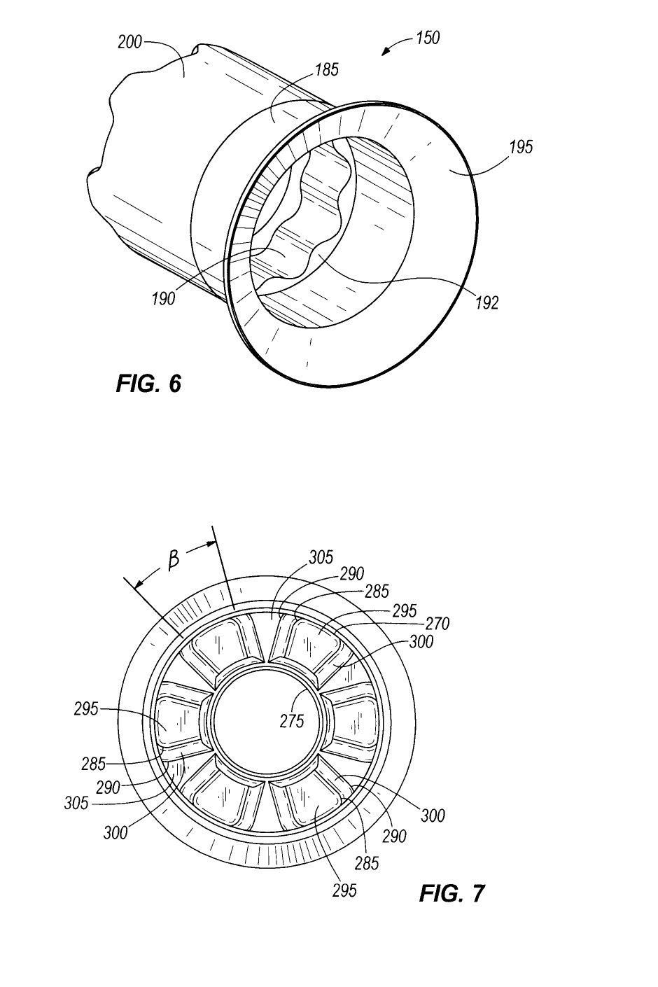

Each of the first and second spindle portions 145, 150 are defined by a hollow body that has an inner diameter and an outer diameter. The outer diameter of each of the first and second spindle portions 145, 150 is about 30 millimeters. In other embodiments, the outer diameter of the first and second spindle portions 145, 150 may be less than or greater than 30 millimeters. FIG. 6 shows the second spindle portion 150 that includes an internal attachment portion 190 disposed circumferentially about the inner diameter of the hollow body. Although not shown, the internal attachment portion 190 is also disposed within the first spindle portion 145 in a similar manner to the internal attachment portion 190 disposed within the second spindle portion 150.

The internal attachment portions 190 include splines 192 (see FIG. 6) that cooperate with the external attachment portions 165 to attach the first and second cranks 130, 135 to the first and second spindle portions 145, 150. The external attachment portion 165 of the first crank 130 attaches to the internal attachment portion 190 of the first spindle portion 145, and the external attachment portion 165 of the second crank 135 attaches to the internal attachment portion 190 of the second spindle portion 150. Epoxy or another adhesive may be disposed adjacent the attachment members 165, 190 to secure the first and second cranks 130, 135 to the first and second spindle portions 145, 150. Alternatively, the composite cranks 130, 135 could be co-molded with the pre-formed (e.g., metallic) spindle portions 145, 150. In embodiments where the first and second cranks 130, 135 and the first and second spindle portions 145, 150 are metallic, welding or other similar fastening methods may be employed to secure the first and second cranks 130, 135 to the first and second spindle portions 145, 150

FIG. 4 shows the first spindle portion 145 that includes a first end 195 and a second end 200. The first end 195 couples to the first crank 130 and includes a raised portion having external spline members 205 and a threaded portion 210. The external spline members 205 are adapted to couple to the spline members 125 of the sprocket assembly 55.

The second end 200 is defined by a radially disposed wall thickness corresponding to a transverse length between the inner and outer diameter of the first spindle portion. The second end 200 includes a first threaded opening 230 and a first engagement mechanism in the form of protrusions or teeth 240 and cavities 245 disposed between the protrusions 240. The first threaded opening 230 is left-hand threaded and in communication with the hollow body of the first spindle portion 145. The illustrated embodiment of the first engagement mechanism includes six protrusions 240 and six cavities 245. Other embodiments of the first engagement mechanism may include fewer than six protrusions 240 and fewer than six cavities 245 (e.g., one protrusion and one cavity). Still other embodiments may include more than six protrusions 240 and more than six cavities 245.

The protrusions 240 and the cavities 245 are evenly spaced circumferentially about the second end 200. Each of the protrusions 240 extends axially outward from the second end 200, and further extends from the outer diameter of the hollow body of the first spindle portion 145 to about the inner diameter of the hollow body of the first spindle portion 145, and substantially across the radial wall thickness of the second end 200.

Each of the protrusions 240 includes an outer planar surface 250 and angular side surfaces 255. As shown in FIG. 4, an angle α is defined by two angular side surfaces 255 of adjacent protrusions 240. The illustrated angle α is about 50 degrees. An angle β is defined by edges of the outer planar surface 250. The illustrated angle β is about 30 degrees. The angle α, the angle β, and the angular relationship of the outer planar surfaces 250 and the side surfaces 255 allow the protrusions 240 and the cavities 245 to be machinable without extensive machining passes, and without complicated, time-consuming, and expensive processes. In some embodiments, each of the protrusions 240 may include an outer rounded surface. In other embodiments, the protrusions 240 may include side surfaces 255 that are substantially orthogonal or perpendicular to the outer planar surface (i.e., 90 degree angle between the outer planar surface 250 and the side surfaces 255).

The cavities 245 are defined by the side surfaces 255 and by an inner planar surface 260 disposed between the protrusions 240. Other embodiments of the cavities 245 may include a rounded inner surface.

FIG. 5 shows the second spindle portion 150 that includes a first end 265 and a second end 270. The first end 265 defines a substantially bell-shaped end that couples to the second crank 135.

FIGS. 5 and 7 show the second end 270 that is defined by a radially disposed wall thickness corresponding to a transverse length between the inner and outer diameter of the second spindle portion 150. The second end 270 includes a second threaded opening 275 and a second engagement mechanism in the form of protrusions or teeth 285 and cavities 290 disposed between the protrusions 285 similar to the first engagement mechanism. The second threaded opening 275 is left-hand threaded and in communication with the hollow body of the second spindle portion 150.

The protrusions 285 and the cavities 290 are evenly spaced circumferentially about the second end 270. Each of the protrusions 285 extends laterally outward from the second end 270, and further extends from the outer diameter of the hollow body of the second spindle portion 150 to about the inner diameter of the hollow body of the second spindle portion 150, and substantially across the radial wall thickness of the second end 270.

The second end 270 includes an outer planar surface 295 and slanted or angular side surfaces 300. Similar to the second end 200, the second end 270 defines the angle α between two angular side surfaces 300 of adjacent protrusions 285. The second end 270 further defines the angle β between edges of the outer planar surfaces 295 to allow the protrusions 240 and the cavities 245 to be machinable without extensive machining passes, and further to rigidly engage the first engagement mechanism with the second engagement mechanism.

The cavities 290 are defined by the side surfaces 300 and by an inner planar surface 305 between the protrusions 285. Other embodiments of the cavities 290 may include a rounded inner surface.

The second engagement mechanism is defined as a mirror image of the second engagement mechanism, and couples to the first engagement mechanism to attach the first spindle portion 145 to the second spindle portion 150. The shape of the protrusions 240 defined by the surfaces 250, 255 substantially match the shape of the protrusions 285 defined by the surfaces 295, 300. Similarly, the shape of the cavities 245 defined by the surfaces 255, 260 substantially match the shape of the cavities 290 defined by the surfaces 300, 305. The matching shapes of the protrusions 240, 285 and the cavities 245, 290 allow similar manufacturing processes to be used to manufacture each of the first and second spindle portions 145, 150. Further, the similarities of the shapes of the protrusions 240, 285 and the cavities 245, 290 provide substantial engagement of the protrusions 240 to with the cavities 290, and the protrusions 285 with the cavities 245 such that a rigid crankset is achieved.

The mirror-image relationship of the first engagement mechanism and the second engagement mechanism provides engagement of corresponding surfaces of each of the protrusions 240, 285 with the cavities 245, 290. Specifically, engagement of the protrusions 240 of the first spindle portion 145 within the corresponding cavities 290 of the second spindle portion 150, and engagement of the engagement of the protrusions 285 of the second spindle portion 150 within the corresponding cavities 245 of the first spindle portion 145 causes the side surfaces 255 to be engaged with the side surfaces 300. The angles α, β are defined such that stress concentrations are limited during engagement of the first and second engagement portions. Extension of the protrusions outward from the second ends 200, 270 and across the radial wall thickness of the second ends 200, 270 defines a relatively large engagement surface area. The limited stress concentrations and the large engagement surface area provide a high-strength engagement of the first spindle portion 145 with the second spindle portion 150 such that movement of each of the spindle portions 145, 150 relative to one another is inhibited.

Referring to FIGS. 3 and 8, the crankset 45 further includes an attachment assembly 310. The attachment assembly 310 includes a first insert or adapter 315, a second insert or adapter 320, and a fastener or bolt 325. The first insert 315 is formed from a steel material and includes a threaded portion 330 and an aperture 335. The threaded portion 330 is left-hand threaded and couples to the first threaded opening 230 in a direction extending from the second end 200 toward the first end 195. The threaded portion 330 is removably threaded to the first threaded opening 230 to allow replacement of the fastener 325, if necessary. The aperture 335 defines a hexagonal portion that allows a hex tool to engage the first insert 315 to facilitate threading into the first threaded opening 230. The first insert 315 captures the fastener 325 within the hollow body of the first spindle portion 145.

The second insert 320 includes a threaded portion 345, a flange 350, and an aperture 355 defining a threaded inner surface. The threaded portion 345 is left-hand threaded and couples to the second threaded opening 275 in a direction from the first end 265 toward the second end 270. The threaded portion 345 can be further coupled to the second threaded opening 275 using an adhesive substance (e.g., LOCTITE, manufactured by Henkel Corporation, having its principal place of business in Düsseldorf, Germany) to inhibit removal of the second insert 320. The flange 350 has a minimum thickness (e.g., 1.5 mm) to withstand tensile forces subjected onto the second insert 320 from tightening the insert in the second threaded opening 275. The flange 350 allows engagement of the second insert 320 with the second spindle portion 150 without allowing the second insert 320 to pass completely through the second threaded opening 275.

The fastener 325 defines an outer diameter and includes a hollow portion that allows the fastener 325 to have increased strength without added weight. The outer diameter of the illustrated fastener 325 is about 11 millimeters, which is about 36 percent of the outer diameter of each of the first and second spindle portions 145, 150. In other embodiments, the outer diameter of the fastener 325 may be between about 25 percent and 80 percent of the outer diameter of the first and second spindle portions. The outer diameter of the fastener 325 cooperates with the radial wall thickness of each of the spindle portions 145, 150, and protrusions 240, 285 to provide a high-strength connection between the first and second engagement mechanisms. The relative size (i.e., diameter) of the fastener 325 is in part dependent upon the material used to form the fastener 325 and the material of the components being coupled, and must be such that adequate strength is provided for the connection of the first spindle portion 145 to the second spindle portion 150. The illustrated fastener 325 is formed from steel material, although other materials, e.g., titanium, may also be used.

The fastener 325 further includes a threaded portion 365 disposed about the outer diameter and a head portion 370. The threaded portion 365 is right-hand threaded and extends partially through the first insert 315. The threaded portion 365 further engages with the second insert 325 to attach the first spindle portion 145 to the second spindle portion 150. The fastener 325 is formed from a steel material.

The head portion 370 couples to an end of the first insert 315 when the fastener 325 is substantially coupled to the second insert 320. A hexagonal aperture 375 extends through the head portion 370 and at least partially into the fastener 325 to allow a tool to engage the fastener 325 to facilitate threading into the second insert 320. The steel head portion 370 coupled to the steel first insert 315 provides a steel-on-steel engagement that allows adequate and consistent torque to be applied between the head portion 370 and the first insert 315 upon tightening of the fastener 325. The relationship between the left-hand threaded portion 330 of the first insert 315 and the right-hand threaded portion 365 of the fastener 325 inhibits loosening of the first insert 315 when the fastener 325 is tightened.

FIG. 8 shows the bearings 80 that are disposed and lightly pressed within the shell 40 in contact with the bearing surface 43 to support rotation of the crankset 45. The illustrated bearings 80 include cartridge bearings, although other bearings could be used instead (e.g., cone bearings, etc.). The retaining clips 85 are disposed within the shell 40 on an inward side of each of the bearings 80 and within the grooves 75. The retaining clips 85 inhibit movement of the bearings 80 toward a center of the bearing surface 75. The sealing members 90 are disposed on an outward side of each of the bearings 80 to inhibit debris and other particles from entering the bearings 80.

The retaining clips 85 are inserted into the grooves 75 prior to insertion of the bearings 80. Once the retaining clips 85 are positioned in the grooves, the bearings 80 are press fit into the shell 40. Each of the sealing members 90 are then positioned outward from and adjacent each of the bearings 80.

The sprocket assembly 55 is fastened to the first spindle portion 145 by coupling the spline members 125 with the external spline members 205. A nut 215 (see FIGS. 3 and 8) couples to the threaded portion 210 to secure the sprocket assembly 55 to the first spindle portion 145. The nut 215 includes threads to couple with the threaded portion 210 to inhibit movement of the sprocket assembly 55 relative to the first spindle portion 145. One side of the nut 215 includes a stepped portion 216 that faces the bearing 80 disposed within the shell 40. The stepped portion 216 is disposed about an outer periphery of the nut 215 and is defined by a diameter that is smaller than the inner diameter defined by the shell 40. The smaller diameter defined by the stepped portion 216 relative to the inner diameter defined by the shell 40 allows rotation of the crank set 45 without engagement of the nut 215 with the shell 40.

To assemble the crankset 45, the second insert 320 is attached to the second threaded opening 275 through the hollow body of the second spindle portion 150 prior to assembly of other components. The left-hand threads of the threaded portion 345 of the second insert 320 and the left-hand threads of the second threaded opening 275 cooperate to allow the second insert 320 to be secured to the second end 270 of the second spindle portion 150, and so that the second insert 320 does not move when the fastener 325 is engaged with the second insert 320.

After attachment of the second insert 320 to the second spindle portion 150, the first and second cranks 130, 135 can be inserted within the respective hollow bodies of the first and second spindle portions 145, 150. The external attachment portions 165 engage the internal attachment portions 190 to attach the first and second cranks 130, 135 to the first and second spindle portions 145, 150. Adhesive or epoxy further secures the first and second cranks 130, 135 to the first and second spindle portions 145, 150. The first and second spindle portions 145, 150 are attached to the respective first and second cranks 130, 135 such that the protrusions 240 align with the cavities 290, and the protrusions 285 align with the cavities 245 prior to engagement of the first engagement mechanism and the second mechanism.

The fastener 325 is passed backward through the first threaded opening 230 prior to attachment of the first insert 315 and after attachment of the first crank 130 to the first spindle portion 145. Once the first insert 315 is threaded into the first threaded opening 230, the fastener 325 is adapted to be partially disposed within the aperture 335. A part of the threaded portion 365 passes through the aperture 335 and extends outward from the second end 200.

The fitting 175 is inserted into the hole 170 and placed in contact with the first crank 130 after connection of the first crank 130 to the first spindle portion 145. Adhesive can be used to secure the fitting 175 to the first crank 130.

In other embodiments, the hole 170 may be sufficiently large to allow the fastener 325 to extend through the crank 130 and into the hollow body of the first spindle portion 145 such that the fastener 325 is passed forward through the first crank portion 145. In those embodiments, the hole 170 may be smooth or threaded, but sufficiently large to allow the fastener 325 to pass through.

Passing the fastener 325 through the sufficiently large hole 170 from outside the crank 130 in the forward direction may allow elimination of the first insert 315 and/or the second insert 320 from the attachment assembly 310. For example, the first insert 315 provides a steel surface that engages the head portion 370 of the fastener 325 when the spindle portions 145, 150 are formed from aluminum. Likewise, the second insert 320 includes steel threads to engage with the steel threaded portion 365 of the fastener 325. However, in embodiments that include titanium or steel spindle portions 145, 150, the first insert 315 and/or second insert 320 may not be required. In these embodiments, the head portion 370 of the fastener 325 can directly engage with a surface of the first spindle portion 145 and the threaded portion 365 of the fastener 325 can threadably engage with the second spindle portion 150.

In still other embodiments, a hole similar to the large hole 170 may be disposed in the second crank 135 adjacent the second end 157, and in communication with the hollow Interior of the second crank 135. The large hole in the second crank 135 allows installation of the second insert 320 from outside the second crank 135 into the second spindle portion 150 after bonding of the second spindle portion 150 to the second crank 135. As stated above the second insert 320 may be eliminated in embodiments that include a titanium or steel second spindle portion 150 because the fastener 325 can directly engage threads disposed within the second spindle portion 150.

To attach the first spindle portion 145 to the second spindle portion 150, the first spindle portion 145 is passed through one end of the shell 40. The second spindle portion 150 is passed through the shell 40 opposite the first spindle portion 145. The bearing surfaces 185 engage the corresponding bearings 80. The second spindle portion 150 engages the first spindle portion 145 such that the first crank 130 is disposed in a first direction and the second crank 135 is disposed in a second direction opposite the first direction (i.e., 180 degrees from each other). The disposition of the protrusions 240 and the cavities 245 on the second end 200 relative to the protrusions 285 and the cavities 290 on the second end 270 facilitate this orientation of the first and second cranks 130, 135.

The fastener 325 threads into the second insert 320 to attach the first spindle portion 145 to the second spindle portion 150. Once the fastener 325 is tightened, the protrusions 240 are securely held within the cavities 290 and the protrusions 285 are securely held within the cavities 245. The outer diameter of the fastener 325 provides adequate strength and stiffness to inhibit failure of the connection of the first and second spindle portions 145, 150 when loads are applied to the assembled crankset 40. The connection of the protrusions 240, 285 and the cavities 245, 290 inhibits rotational movement of the first spindle portion 145 and the second spindle portion 150 relative to each other. The cap 180 is threaded into the fitting 170 to inhibit dirt and debris from entering the hollow bodies of the first crank 130 and the first spindle portion 145. The cap 180 is threaded into the fitting 175 to inhibit dirt and debris from entering the hollow bodies of the first crank 130 and the first spindle portion 145.

Various features and advantages of the invention are set forth in the following claims.

1-23. (canceled)

24. A crankset comprising:
a first crank and a second crank, each of the first crank and the second crank having an end adapted to engage a pedal;
a first spindle portion including a first end coupled to the first crank and a second end having a plurality of protrusions and a plurality of cavities that are circumferentially spaced about the second end, at least one of the plurality of protrusions having outer surfaces at an angle with respect to each other to define a radial taper of the at least one protrusion;
a second spindle portion including a first end coupled to the second crank and a second end having a plurality of protrusions and a plurality of cavities that are circumferentially spaced about the second end, at least one of the plurality of protrusions having outer surfaces at an angle with respect to each other to define a radial taper of the at least one protrusion, and the plurality of protrusions of the second spindle portion engaged with the plurality of cavities of the first spindle portion and the plurality of cavities of the second spindle portion engaged with the plurality of protrusions of the first spindle portion; and
an attachment assembly extending through the first spindle portion and the second spindle portion to secure the second spindle portion to the first spindle portion.

25. The crankset of claim 24, wherein each of the first crank and the second crank includes an external attachment portion, and wherein each of the first spindle portion and the second spindle portion includes an internal attachment portion engaged with the corresponding external attachment portion of the first and second cranks to attach the first and second cranks to the first and second spindle portions.

26. The crankset of claim 25, wherein the external attachment members of the first and second cranks include external spline members, and wherein the internal attachment members of the first and second spindle portions include internal spline members.

27. The crankset of claim 24, wherein the first crank includes a bent end attached to the first spindle portion, and wherein the second crank includes a bent end attached to the second spindle portion.

28. The crankset of claim 24, wherein the first crank is bonded to the first spindle portion, and wherein the second crank is bonded to the second spindle portion.

29. The crankset of claim 24, wherein each of the first spindle portion and the second spindle portion includes a plurality of teeth and a plurality of cavities, and wherein the plurality of teeth of each of the first spindle portion and the second spindle portion engage the plurality of cavities of the other of the first spindle portion and the second spindle portion.

30. The crankset of claim 29, wherein the plurality of teeth and the plurality of cavities are evenly spaced circumferentially about the second end of the first spindle portion and the second spindle portion.

31. The crankset of claim 24, wherein the first and second cranks each include composite material.

32. The crankset of claim 24, wherein the first and second spindle portions each include an alloy.

33. A crankset comprising:
a first crank and a second crank, each of the first crank and the second crank having an end adapted to engage a pedal;
a first spindle portion including a first end coupled to the first crank and a second end;
a second spindle portion including a first end coupled to the second crank and a second end coupled to the second end of the first spindle portion;
an insert secured to the second spindle portion; and
a fastener extending through the first spindle portion and coupled to the insert to attach the second spindle portion to the first spindle portion.

34. The crankset of claim 33, further comprising an adapter secured to the first spindle portion.

35. The crankset of claim 34, wherein the fastener extends through the adapter.

36. The crankset of claim 33, wherein each of the first spindle portion and the second spindle portion includes a plurality of teeth and a plurality of cavities, and wherein the plurality of teeth of the spindle portion member and the second spindle portion engage the plurality of cavities of the other of the first spindle portion and the second spindle portion.

37. The crankset of claim 33, wherein the first and second cranks each include composite material.

38. The crankset of claim 33, wherein the first and second spindle portions each include an alloy.

39. The crankset of claim 33, wherein the fastener includes a substantially hollow portion.

40. The crankset of claim 33, wherein the fastener defines a first diameter and the first and second spindle portions define a second diameter, and wherein the first diameter is between about 25 percent and 80 percent of the second diameter.

41. The crankset of claim 40, wherein the first diameter is about 36 percent of the second diameter.

42. A crankset comprising:
a first crank and a second crank, each of the first crank and the second crank having a first end adapted to engage a pedal and a second end having one of internal and external spline portions; and
a spindle including a first end having the other of internal and external spline portions engaged with the first crank and a second end having the other of internal and external spline portions engaged with the second crank.

43. The crankset of claim 42, wherein the first and second cranks include the external spline portions, and wherein the spindle includes the internal spline portions.

44. The crankset of claim 43, wherein the external spline portions are disposed on a bent end of each of the first crank and the second crank, and wherein the bent end is engaged with the spindle.

45. The crankset of claim 42, wherein the first crank and the second crank are each bonded to the spindle.

46. A crankset comprising:
a first crank and a second crank, each of the first crank and the second crank having an end adapted to engage a pedal;
a first spindle portion including a first end coupled to the first crank and a second end having a plurality of protrusions and a plurality of cavities that are circumferentially spaced about the second end;
a second spindle portion including a first end coupled to the second crank and a second end having a plurality of protrusions and a plurality of cavities that are circumferentially spaced about the second end, at least one of the plurality of protrusions of the second spindle portion is substantially the same as at least one of the plurality of protrusions of the first spindle portion, and the plurality of protrusions of the second spindle portion engaged with the plurality of cavities of the first spindle portion and the plurality of cavities of the second spindle portion engaged with the plurality of protrusions of the first spindle portion; and
an attachment assembly extending through the first spindle portion and the second spindle portion to secure the second spindle portion to the first spindle portion.
